(19) United States
(12) Patent Application Publication
(10) Pub. No.: US 2011/0149325 A1
(43) Pub. Date: Jun. 23, 2011

(54) METHOD OF MANAGING FILES OF IMAGE FORMING APPARATUS AND IMAGE FORMING APPARATUS TO PERFORM THE METHOD

(75) Inventors: Hyun-seung KIM, Namyangju-si (KR); Yong-jo Park, Suwon-si (KR)

(73) Assignee: Samsung Electronics Co., Ltd, Suwon-si (KR)

(21) Appl. No.: 12/974,217

(22) Filed: Dec. 21, 2010

(30) Foreign Application Priority Data
Dec. 21, 2009 (KR) 10-2009-128335

(51) Int. Cl. G06K 15/02; G06F 3/12

(52) U.S. Cl. 358/1.13; 358/1.15; 358/1.16

(57) ABSTRACT

A method of managing files of an image forming apparatus having a display unit and connectable to at least one storage medium including a document box is provided. The method includes connecting the storage medium to the image forming apparatus, determining if an information file corresponding to document box exists in the storage medium, searching for at least one file stored in the at least one document box corresponding to the information file in response to determining that the information file exists, and displaying at least one of the searched file and the document box on the display unit.

### CROSS-REFERENCE TO RELATED APPLICATIONS

This application claims priority under 35 U.S.C. §119(a) from Korean Patent Application No. 10-2009-0128335, filed on Dec. 21, 2009, in the Korean Intellectual Property Office, the disclosure of which is incorporated herein in its entirety by reference.

### BACKGROUND

1. Field of the Invention

The present general inventive concept relates to a method of managing files of an image forming apparatus and an image forming apparatus to perform the method

2. Description of the Related Art

An image forming apparatus including at least one of a printer, a scanner, a multi-function peripheral devices, and the like may use a document box to perform at least one of a variety of functions such as a printing function, a copying function, a scanning function, a fax sending/receiving function, an e-mail sending/receiving function, and a file transferring function to a server. The image forming apparatus may include a storage device to store data created during the performing of the functions. The data stored in the storage device may be organized according to various attributes, such as file name, file type, creation date, file size, etc. Therefore, stored data can be organized and easily accessible such that a user can conveniently perform a function, i.e. print, scan, email, etc. using the stored data.

### SUMMARY

The present general inventive concept provides a method of managing files using a document box in a removable storage medium and an image forming apparatus to perform the method.

Additional features of the present general inventive concept will be set forth in part in the description which follows and, in part, will be obvious from the description, or may be learned by practice of the present general inventive concept.

According to a feature of the present general inventive concept, there is provided a method of managing files of an image forming apparatus including a display unit and connectable to at least one storage medium having a document box, the method including the operations of connecting the storage medium to the image forming apparatus; determining if an information file corresponding to the at least one document box exists in the storage medium; searching for at least one file stored in the document box corresponding to the existed information file in response to determining that the information file exists; and displaying at least one of the searched file and the document box on the display unit, wherein the image forming apparatus performs at least one of a printing function, a scanning function, a copying function, a fax sending function, an e-mail sending function, a file transferring function to a server, and a document box function.

According to a feature of the present general inventive concept, there is provided an image forming apparatus connectable to at least one storage medium having a document box, including a communication unit to connect the storage medium to the image forming apparatus; a determining unit to determine if an information file corresponding to the at least one document box exists in the connected storage medium; a searching unit for at least one file stored in the document box corresponding to the existed information file in response to determining that the information file exists; a displaying unit to display at least one of the searched file and the document box on the display unit; and a control unit to control the image forming apparatus such that the image forming apparatus performs at least one of a printing function, a scanning function, a copying function, a fax sending function, an e-mail sending function, a file transferring function to a server, and a document box function.

According to another feature of the present general inventive concept, there is provided a method of managing files of an image forming apparatus having a display unit and a storing unit and connectable to at least one storage medium having a document box, the method including the operations of connecting the storage medium to the image forming apparatus; displaying an image corresponding to a document box function on the display unit of the image forming apparatus; selecting a location where a new document box will be created in one of the storing unit and the storage medium through the displayed image; creating the new document box at the selected one of the storing unit and the storage medium; and storing the file in the new document box.

According to a feature of the present general inventive concept, there is provided an image forming apparatus connectable to at least one storage medium, comprising a user interface to select an image file and the at least one storage medium, a document box creating module to create a document box in a selected storage medium to include with the document box an image file selected via the user interface, an information creating module to create an information file including box attribute information corresponding to the document box, and a managing module to extract file attribute information from the selected image file and add the extracted file attribute information to the information file.

According to still another feature of the present general inventive concept, there is provided a method of managing files processed by an image forming apparatus connectable to at least one storage medium, comprising selecting a storage medium from among the at least one storage medium, creating a document box in the selected storage medium, creating an information file including box attribute information corresponding to the document box, selecting an image file to be included with the document box, extracting file attribute information from the selected image file, and adding the extracted file attribute data to the information file.

### BRIEF DESCRIPTION OF THE DRAWINGS

The above and other features and advantages of the present general inventive concept will become more apparent by describing in detail exemplary embodiments thereof with reference to the attached drawings in which:

The above and/or other features of the present general inventive concept will become apparent and more readily appreciated from the following description of the exemplary embodiments, taken in conjunction with the accompanying drawings, in which:

FIG. 1 is a schematic view of an image forming system according to an exemplary embodiment of the present general inventive concept;

FIG. 2 is a schematic view illustrating an example of an information file according to an exemplary embodiment of the present general inventive concept;

FIG. 3 is a schematic view illustrating an example of a graphic user interface (GUI) representing a list of a document box displayed on an image forming apparatus, according to an exemplary embodiment of the present general inventive concept;

FIG. 4 is a schematic view illustrating an example of a GUI that creates a document box displayed on an image forming apparatus, according to an exemplary embodiment of the present general inventive concept;

FIG. 5 is a flowchart illustrating a method of managing files of the image forming apparatus, according to an exemplary embodiment of the present general inventive concept;

FIG. 6 is a flowchart illustrating a method of managing files of the image forming apparatus, according to another exemplary embodiment of the present general inventive concept; and

FIG. 7 is a flowchart illustrating a method of managing files of the image forming apparatus, according to an exemplary embodiment of the present general inventive concept.

### DETAILED DESCRIPTION OF THE EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

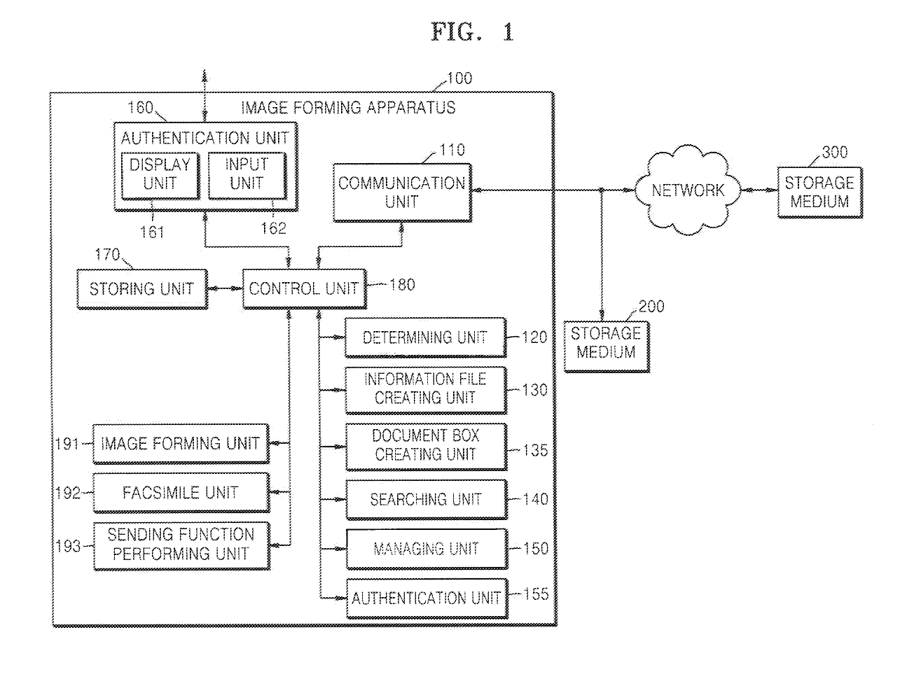

FIG. 1 is a schematic view of an image forming system according to an exemplary embodiment of the present general inventive concept. Referring to FIG. 1, the image forming system of at least one exemplary embodiment includes an image forming apparatus 100 and storage mediums 200 and 300. In the present embodiment, the image forming system includes one image forming apparatus 100 and two storage mediums, namely the storage mediums 200 and 300; however, the present general inventive concept is not limited thereto and the image forming system may include more than one image forming apparatus 100 and at least one store medium. For simplicity, an exemplary case where one storage medium 200 is connected to one image forming apparatus 100 will be described hereinafter. However, the present inventive concept is not limited to this, and it will be understood by those of ordinary skill in the art that the description also applies to the case where a plurality of the storage media 200 are connected to the image forming apparatus 100.

The image forming apparatus 100 and the storage medium 200 may send and receive data through at least one of wire network communication, wireless network communication, and wire serial communication. Here, the network may be the Internet, a local area network, a wireless local area network, a wide area network, a personal area network, or the like. The wire serial communication includes local communication using a universal serial bus (USB) and the like. However, the present inventive concept is not limited to this. That is, other communications and networks that can send and receive information may also be used.

The image forming apparatus 100 of FIG. 1 illustrates elements relating to an exemplary embodiment. Accordingly, it will be understood by those of ordinary skill in the art that the image forming apparatus 100 may further include other elements in addition to the elements illustrated.

Referring to FIG. 1, the image forming apparatus 100 includes a communication unit 110, a determining unit 120, an information file creating unit 130, a document box creating unit 135, a searching unit 140, a managing unit 150, an authentication unit 155, a user interface unit 160, a display unit 161, an input unit 162, a storing unit 170, a control unit 180, an image forming unit 191, a facsimile unit 192, and a sending function performing unit 193.

The image forming apparatus 100 stores files to process an image file, including, but not limited to, performing a printing function, a scanning function, a copying function, a fax sending function, an e-mail sending function, a file transferring function to a server, and the like. Here, the files may be stored in the storing unit 170 of the image forming apparatus 100. In at least one exemplary embodiment, each of the files includes, but is not limited to, at least one of scan data, facsimile data, e-mail data, and print data to perform the printing function, scanning function, copying function, fax sending function, e-mail sending function, file transferring function to the server, and the like.

In addition, the image forming apparatus 100 performs the printing function, scanning function, copying function, fax sending function, e-mail sending function, file transferring function to the server, and the like using the stored files.

The communication unit 110 connects the storage medium 200 to the image forming apparatus 100. The communication unit 110 of at least one exemplary embodiment may be at least one of, for example, a modem used to send and receiving a fax, a network module to communicate with network, a USB host module to establish a data sending/receiving channel to/from a removable storage medium, and the like.

In at least one exemplary embodiment, the storage medium 200 may include, but is not limited to, a removable storage medium, a USB memory, a memory card, an external hard disk drive (HDD), a computer system connectable to the image forming apparatus 100, a server connectable to the image forming apparatus 100, and the like. Here, the computer system connectable to the image forming apparatus 100 and the server connectable to the image forming apparatus 100 includes a shared folder existing in the computer system and the server. Therefore, the storage medium 200 may be directly connected to the image forming apparatus 100 by a user or connected to the image forming apparatus 100 through a network. Accordingly, the user may conveniently manage the files of the image forming apparatus 100 using the storage medium 200 separated from the image forming apparatus 100. Further, since the storage medium 200 may be portable and mobile, the user may manage the files with an enhanced security function.

The determining unit 120 determines if there is an information file corresponding to at least one document box in the storage medium 200. Here, the document box assists to efficiently managing the stored files in accordance with file attributes. In at least one exemplary embodiment, the file attributes may be information regarding, for example, a file owner, a file type, a file creation time, a file creation place, a file format, security information set in the file, and/or the like.

The document box may be used to store the files classified based on the file attributes. The storage medium 200 connected to the image forming apparatus 100 performs the printing function, scanning function, copying function, fax sending function, e-mail sending function, file transferring function to the server, and the like by efficiently managing the stored files using the document box.

In addition, the document box may be realized by an information file in the storage medium 200. At this point, the information file is a text file including box attribute information regarding the document box, and file attribute information regarding the files stored in the document box. Here, the box attribute information regarding the document box includes, but is not limited to, a document box name, a document box owner, and information regarding whether security of the document box is set or not. The file attribute information regarding the files stored in the document box includes, but is not limited to, a file name, information regarding whether security of the file exists or not, a file format, and a file storage path.

The information file creating unit 130 creates an information file corresponding to the document box when the determining unit 120 determines that no information file exists. Here, the document box may be created by the document box creating unit 135. However, it will be understood by those of ordinary skill in the art that the information file creating unit 130 may allow the information file corresponding to the document box to be created in the storage medium 200 depending the user's settings. The document box corresponding to the information file may be realized in the storage medium 200 with the information file of the present embodiment.

The information file created by the information file creating unit 130 is sent to the storage medium 200 via the communication unit 110 and stored in the storage medium 200. As described above, the information file may be stored in the storage medium 200, and the image forming apparatus 100 allows the document box to be realized in the storage medium 200 by recognizing the information file stored in the storage medium 200.

The document box creating unit 135 creates the document box. That is, the document box creating unit 135 creates the document box in at least one of the storing unit 170 and the storage medium 200 in accordance with the user's selection. In at least one exemplary embodiment, the document box may be created by the user manipulating the user interface unit 160 of the image forming apparatus 100 by touching an icon representing a creation of the document box. The scan data, print data, fax data, and/or the like may be stored in the document box created by the document box creating unit 135.

When the determining unit 120 determines that the information file exists, the searching unit 140 searches for at least one file stored in the document box corresponding to the existing information file. In addition, the searching unit 140 searches for at least one file that is usable in the image forming apparatus 100 among the files stored in the storage medium 200. Here, the file usable in the image forming apparatus 100 includes a document file that is capable of performing the printing function, the scanning function, copying function, the fax sending function, the e-mail sending function, and the file transferring function to the server, and/or the like in the image forming apparatus 100. The searching unit 140 searches for file extensions of the files stored in the storage medium 200 to find out a file extension of the document file. In at least one exemplary embodiment, the file extension of the document file may include, but is not limited to, pdf, doc, hwp, gul, txt, jpg, bmp, and the like.

The managing unit 150 adds file attribute information regarding the file searched by the searching unit 140 and usable in the image forming apparatus 100 to the information file. When the file attribute information regarding the searched file is added to the information file, the searched file is included in the document box representing the information file.

For example, when a file “A” is created in a device such as a general-purpose computer system and stored in the storage medium 200, the searching unit 140 searches for the file “A” created in the device and the managing unit 150 adds file attribute information regarding the searched file “A” to the information file. Accordingly, the file “A” may be contained in a corresponding document box realized by the information file. That is, the user may perform a variety of functions using the document box containing the file “A” stored in the storage medium 200 in the image forming apparatus 100.

Further, the managing unit 150 allows attribute information including, but not limited to, scan data, print data, fax data, and e-mail data to be contained in the information file. The scan data may be created by the image forming apparatus 100 performing the scan function and the fax data may be created by the image forming apparatus 100 performing the fax receiving/sending function. The e-mail data may be created by the image forming apparatus 100 performing the e-mail sending/receiving function. In addition, the print data may be received from a host device (not shown) connected to the image forming apparatus 100.

According to the user's settings, file attribute information regarding the scan data, print data, fax data, and/or e-mail data may be added to the information file representing the document box of the storage medium 200 automatically and/or according to the user's settings. That is, the scan data, print data, fax data, and e-mail data existing in the image forming apparatus 100 may be stored in the storage medium 200. At this point, the file attribute information regarding the scan data, print data, fax data, and e-mail data may be added to the information file. Therefore, files representing the scan data, print data, fax data, and/or e-mail data may be contained in the document box of the storage medium 200.

Accordingly, by realizing the document box in the storage medium 200, a variety of functions performed by the image forming apparatus 100 can be conveniently performed for the files stored in the storage medium 200.

The authentication unit 155 verifies log in information in the image forming apparatus 100. That is, the authentication unit 155 receives the log in information from one of the communication unit 110 and the user interface unit 160 and verifies the attained log in information. At this point, the log in information means an identifier to identify the user, such as an identification and password of the user of the image forming apparatus 100.

In at least one exemplary embodiment, the storing unit 170 stores account information of the user of the image forming apparatus 100 therein and the authentication unit 155 authenticates the user of the image forming apparatus 100 by comparing the attained log in information with the account information stored in the storing unit 170. Only an authenticated user may access the image forming apparatus 100 to manage the files of the image forming apparatus 100. However, a person who is not authenticated may use some of the functions of the image forming apparatus 100 according to settings. For example, even the user who is not authenticated may access a shared document box that is one of the document boxes.

The user interface unit 160 receives input information from the user and displays output information. The user interface unit 160 includes the display unit 161 and the input unit 162. The display unit 161 displays at least one of the document box realized by the information file and a file list stored in the document box. That is, the display unit 161 displays at least one of the files, which is searched by the searching unit 140. In addition, the display unit 162 may also display the document box stored in the image forming apparatus 100.

The display unit 161 may display the document box existing in the storage medium 200 and the document box existing in the image forming apparatus 100. The display unit 161 displays at least one document box as an icon and the like. In addition, the display unit 161 displays a device, in which the document box exists using an identifier identifiable by the user. For example, the identifier identifiable by the user may be “USB1” and the like.

In addition, the user may create the document box in the image forming apparatus 100 and/or the storage medium 200 using the input unit 162. When the input unit 162 receives the input information regarding the creation of the document box from the user, the document box creating unit 135 creates the document box corresponding to the received input information and the information file creating unit 130 creates the information file corresponding to the document box.

In at least one exemplary embodiment, the input unit 162 receives the input information from the user and the display unit 161 provides the output information to the user. It will be understood by those of ordinary skill in the art that the display unit 161 and the input unit 162 of the image forming apparatus 100 may be provided in the form of a combination unit such as a touchpad.

For example, the user interface unit 160 of at least one exemplary embodiment includes an input/output unit such as, for example, a keyboard, a mouse, a touchpad, a display to display a graphic user interface or a local user interface, and the like, which are provided in the image forming apparatus 100, and a software module operating the input/output unit.

The storing unit 170 stores the document box and the files contained in the document box. The storing unit 170 of at least one exemplary embodiment may be at least one of, for example, a read only memory (ROM), a random access memory (RAM), a flash memory, a HDD which is a type of a magnetic computer memory unit, and an optical disk drive.

The control unit 180 controls the overall functions of the image forming apparatus 100. That is, the control unit 180 controls at least one of the printing function, scanning function, copying function, fax sending function, e-mail sending function, file transferring function to the server, and the document box function in the image forming apparatus 100.

In addition, when the user selects at least one of the files displayed on the display unit 161 and further selects a function the user wants to perform using the selected file, the control unit 180 controls the image forming apparatus 100 based on the input information such that the function supported by the image forming apparatus 100 can be performed for the selected file. That is, for the selected file, the function (e.g., the printing function, scanning function, copying function, fax sending function, or the like) selected by the user is performed.

In addition, when the storage medium 200 is connected to the image forming apparatus 100, the control unit 180 controls the image forming apparatus 100 using the information file existing in the storage medium 200 to efficiently manage the files stored in the storage medium 200.

Accordingly, the files stored in a plurality of the storage media 200 can be efficiently managed in the image forming apparatus 100 by the document box.

The control unit 180 may renew the information file representing the document box stored in the storage medium 200. That is, the determining unit 120 determines if the information file exists in the storage medium 200. When the determining unit 120 determines that the information file does not exist, the information file creating unit 130 creates the information file. In addition, the searching unit 140 searches for a file that is usable in the image forming apparatus 100 among the files stored in the storage medium 200 and the managing unit 150 adds file the attribute information regarding the searched file to the information file. Accordingly, the storage medium 200 is initially connected to the image forming apparatus 100 or, when the document box is not realized in the storage medium 200, the control unit 180 determines whether the document box is automatically realized in the storage medium 200. However, depending on the user's settings, the document box may be created in the storage medium 200 by the document box creating unit 135 and the information file corresponding to the created document box may be created by the information file creating unit 130.

When the determining unit 120 determines that an information file exists in the storage medium 200, the control unit 180 may renew the information file of the storage medium 200. At this point, the renewal may be automatically performed in accordance with a predetermined condition or performed by the request of the user. The predetermined condition may be a predetermined period (e.g., one month) since the storage medium 200 has been connected to the image forming apparatus 100.

That is, the searching unit 140 searches for the file that is usable in the image forming apparatus 100 among the files stored in the storage medium 200, and the control unit 180 compares the searched file with the information file stored in the storage medium 200.

When it is determined from the comparison result that the information regarding the file searched by the searching unit 140 is not contained in the information file, the control unit 180 allows the information regarding the searched file to be contained in the information file. Accordingly, the file contained in the information file may be added to the document box representing the information file. Accordingly, the list of the files stored in the document box of the storage medium 200 can be renewed.

When it is determined from the comparison result that the file contained in the information file does not exist in the file searched by the searching unit 140, the control unit 180 deletes the information regarding the file that does not exist in the searched file from the information file. Accordingly, when the file that does not substantially exist but only the information regarding this file exists, this file may be deleted. This prevents the user from requesting the performance of the function of the file that does not substantially exist.

As described above, as the information file stored in the storage medium 200 is periodically renewed, user convenience can be improved. In addition, the renewal work may be performed during the performance of the printing function, copying function, and/or the like and thus user convenience may be further improved.

The image forming apparatus 100 of the present embodiment may improve security of the files stored in the storage medium 200 using the security setting. When the user selects one of the files stored in the document box realized by the information file stored in the storage medium 200 and security information of the selected file is set, the user interface unit 160 receives the security information from the user. At this point, the security information may be, for example, a password set corresponding to the selected file. When the security information obtained from the user is identical to the security information set corresponding to the selected file, the control unit 180 controls such that the function requested by the user is performed.

At this point, the control unit 180 performs the function requested by the user with reference to the information corresponding to the selected file. That is, the control unit 180 accesses a storage location of the file selected by the user with reference to the information file in which the information corresponding to the file selected by the user is contained and performs the function requested by the user. For example, when the user requests the performance of the printing function, the control unit 180 accesses the storage location of the file selected by the user with reference to the information file and performs the printing function corresponding to the selected file.

In the image forming apparatus 100 of the present embodiment, the image forming unit 191, the facsimile unit 192, the sending function performing unit 193 perform a variety of functions. The image forming unit 191 performs the printing function of the file. The facsimile unit 192 performs the fax sending function of the file. The sending function performing unit 193 performs the sending of the file to the external device such as the server, removable storage medium, computer system, and/or the like.

Accordingly, the image forming apparatus 100 creates the information file realizing the document box to conveniently manage the files stored in the storage medium 200 and stores the created information file in the storage medium 200.

As described above, by using the user interface unit 160 using the information file defined between the image forming apparatus 100 and the storage medium 200, the image forming apparatus 100 may recognize the storage medium 200 as the document box. In addition, since the image forming apparatus 100 may attain the information regarding the files stored in the storage medium 200 using only the information file, there is no need to perform an unnecessary copying work of the file.

The storage medium 200 receives the information from the image forming apparatus 100 and stores the received information therein. At this point, the information file may be stored at a predetermined location of the storage medium 200. That is, the information file may be stored in a folder in which the files of the storage medium 200 are stored or in another folder created to realize the document box function.

The information file exists corresponding to the document box. One information file exists in one corresponding document box. The information regarding the file stored in the document box may be contained in the information file. However, the present general inventive concept is not limited to this. That is, a plurality of information files corresponding to one document box may exist. In addition, one information file corresponding to a plurality of the document boxes may exist. Here, it will be understood by those of ordinary skill in the art that the information file may be realized in the form of metadata.

Further, the information file stored in the storage medium 200 may be renewed by the image forming apparatus 100. That is, the searching unit 140 of the image forming apparatus 100 searches for the file that is usable in the image forming apparatus 100 among the files stored in the storage medium 200. At this point, when the file attribute information regarding the searched file is not contained in the created information file, the control unit 180 adds the attribute information regarding the searched file to the information file and the communication unit 110 sends the information file in which the information regarding the searched file is contained to the storage medium 200.

The storage medium 200 receives the information file in which the file attribute information regarding the searched file is contained and renews the current information file using the received information file.

Therefore, when a new file is added to the storage medium 200, information regarding the new file is contained in the information file and thus the new file may be added to the document box.

The storage medium 200 of the present embodiment may be at least one of, for example, a removable storage medium, a USB memory, a memory card, an external HDD, a shared folder existing in a general-purpose computer system connectable to the image forming apparatus 100, a server connectable to the image forming apparatus 100, and the like. That is, the user may directly connect the removable storage medium to the image forming apparatus 100 or may connect the shared folder existing in the general-purpose computer to the image forming apparatus 100 through a network.

As described above, since the storage medium 200 having mobility, such as the removable storage medium, USB memory, and/or the like, can be used, the portability of the data files can be improved. In addition, in case of the storage medium 200 having mobility, the user may carry the storage medium 200 and thus the security of the files stored in the storage medium 200 can be enhanced. As the document box function is realized in the storage medium 200, a plurality of functions that can be performed in the image forming apparatus 100 can be conveniently performed and thus the usability of the data files can be enhanced.

FIG. 2 is a schematic diagram illustrating an example of an information file 21, according to an exemplary embodiment. Referring to FIG. 2, the information file 21 is created in the image forming apparatus 100 in the form of a text file and stored in the storage medium 200. The information file 21 includes box attribute information of the document box and file attribute information of the files stored in the document box. Here, the box attribute information of the document box may include, but is not limited to, a document box name 22 and owner information 23 such as a document box owner name, an e-mail ID, and/or the like. In addition, the file attribute information of the files stored in the document box may include, but is not limited to, a file name 24, information 25 on whether the security is set or not, a file format 26, and a storage path 27.

Accordingly, the image forming apparatus 100 performs the function requested by the user with reference to the information file 21 stored in the storage medium 200. For example, when the storage medium 200 storing the information file 21 is connected to the image forming apparatus 100, the document box having a name “Default” and the files stored in the “Default” document box may be displayed on the user interface unit 160 of the image forming apparatus 100. When the user wants to perform the printing function of the file having a name “doc1.pdf,” the control unit 180 of the image forming apparatus 100 accesses the location where the file is stored with reference to “any_folder/doc1.pdf”, which is the storage path 27 of the file of the information file 21 stored in the storage medium 200, and performs the printing function requested by the user. In addition, when the security is set for the file, “private” may appear in the information file 21. In this case, the control unit 180 of the image forming apparatus 100 may request the user to input the security information.

Accordingly, the image forming apparatus 100 may perform the function requested by the user with reference to only the information file 21, without performing the searching work for all of the files stored in the storage medium 200.

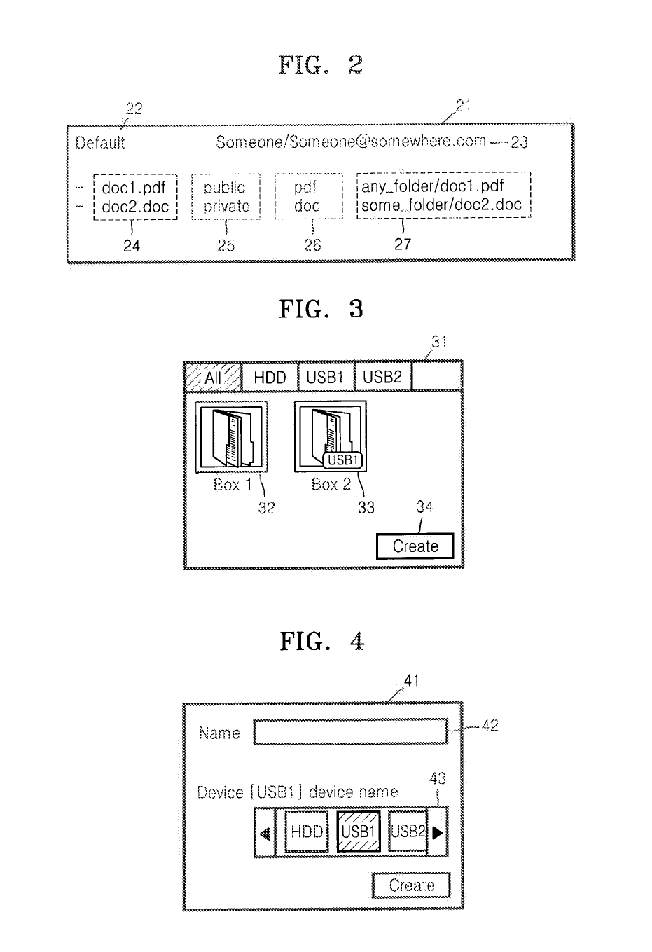

FIG. 3 is a schematic view illustrating an example of a graphic user interface (GUI) 31 representing a list of the document boxes displayed on the image forming apparatus 100, according to an embodiment of the present general inventive concept. Referring to FIG. 3, there is shown the GUI 31 representing a list of the document box displayed on the display unit 161 of the image forming apparatus 100. Referring to the GUI 31, a box 32 (Box 1) that is the document box stored in the image forming apparatus 100 and a box 33 (Box 2) that is the document box stored in a USB 1 are shown as an example of the storage medium 200.

That is, when the storage medium 200 is connected to the image forming apparatus 100 and the determining unit 120 determines that the information file exists in the storage medium 200, the control unit 180 allows the document box represented by the information file to be displayed in the form of the GUI 31 on the display unit 161 with reference to the information file. At this point, a device name such as “USB 1” representing the device in which the document box is stored may be further displayed in the GUI 31. Therefore, even when a plurality of the storage media 200 is connected and/or a plurality of the document boxes is stored, the function of the document boxes can be conveniently used.

When the user selects an icon representing the document box displayed on the display unit 161 of the image forming apparatus 100 or a display panel that is an example of the user interface unit 160 to which the input unit 162 is further embedded, the display unit 161 displays a list of the files stored in the document box. For example, when the user selects the icon representing the box 33 (Box 2), the user interface unit 160 displays the list of the files represented by the information regarding the files contained in the information file corresponding to the box 33 (Box 2). Here, when the user selects one of the files listed in the file list displayed in the user interface unit 160, the control unit 180 accesses an actual location of the selected file with reference to the information contained in the information file to perform the function requested by the user.

The user creates a new document box by selecting an icon “Create” 34. The user may select the icon “Create” 34 by touching the display panel that is an example of the user interface unit 160 provided on the image forming apparatus 100.

FIG. 4 is a schematic view illustrating an example of a GUI 41 that creates the document box displayed on the image forming apparatus 100, according to an exemplary embodiment of the present general inventive concept. Referring to FIG. 4, there is shown the GUI 41 that creates the document box displayed on the user interface unit 160 of the image forming apparatus 100. Referring to the GUI 41, icons may be included illustrating a document box name input field 42 and a selection scroll bar 43 where the document box is stored illustrated. Accordingly, the user creates the document box by selecting one of the storing unit 170 of the image forming apparatus 100 and the storage medium 200. At this point, when the user inputs information to create the document box in the storage medium 200, the document box creating unit 135 of the image forming apparatus 100 creates the document box and the information file creating unit 130 creates the information file corresponding to the created document box. The communication unit 110 sends the created information file to the storage medium 200. Accordingly, the information file realizing the document box is stored in the storage medium 200.

Further, the user may select one of the files stored in the image forming apparatus 100 or the storage medium 200, which will be contained the created document box. When the user selects the file that will be contained in the document box, the managing unit 150 may extract file attribute information from the selected file, and add the file attribute information regarding the selected file that will be contained in the created document box to the information file.

Accordingly, the user may conveniently create the document box via the image forming apparatus 100, which may be stored in the storage medium 200. In addition, the user conveniently allows the files stored in the storage medium 200 or the image forming apparatus 100 to be contained in the document box. Thereafter, an image forming apparatus may locate the selected file based on the information file, and may process the file accordingly.

FIG. 5 is a flowchart illustrating a method of managing the files of the image forming apparatus 100, according to an exemplary embodiment of the present general inventive concept.

In operation 501, the communication unit 110 connects the storage medium 200 to the image forming apparatus 100. When the user connects the storage medium 200 to the image forming apparatus 100, the storage medium 200 may be recognized by the communication unit 110 in the image forming apparatus 100.

In operation 502, the determining unit 120 determines if an information file, which corresponds to at least one document box, exists in the storage medium 200. The determining unit 120 may determine if the information file exists in the storage medium 200 by scanning directories of the storage medium 200.

In operation 503, when it is determined that the information file exists in the storage medium 200, the searching unit 140 searches for one of the files stored in the document box, which corresponds to the existing information file.

In operation 504, the display unit 161 displays at least one of the searched file and the document box.

Accordingly, the files of the image forming apparatus 100 and the files of the storage medium 200 may be managed by the information file stored in the storage medium 200.

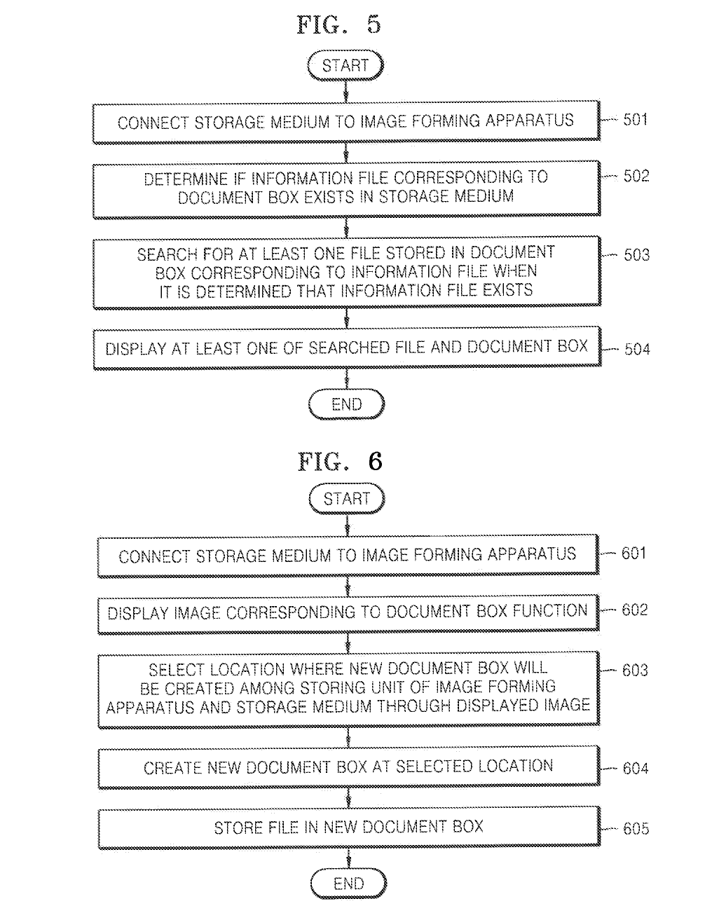

FIG. 6 is a flowchart illustrating a method of managing the files of the image forming apparatus 100, according to another exemplary embodiment of the present general inventive concept.

In operation 601, the communication unit 110 connects the storage medium 200 to the image forming apparatus 100.

In operation 602, the display unit 161 displays an image corresponding to the document box function. At this point, the image corresponding to the document box function may be to create, amend, delete, and view the document box and to perform the printing function, fax sending function, e-mail sending function, file transferring function to the server, and the like. That is, the user may perform the document box function using the image corresponding to the document box function. Further, the document box function is not limited to the ones listed above, and a variety of other functions may further exist depending on the use environment.

In operation 603, the input unit 162 receives information regarding the selection of a location where a new document box is created in the storing unit 170 of the image forming apparatus 100 or the storage medium 200 from the image displayed on the display unit 161. That is, in operation 602, the user selects the location where the document box is created using the input unit 162 with reference to the image displayed on the display unit 161 and corresponding to the document box function.

In operation 604, the document box creating unit 135 creates the new document box at the selected location.

In operation 605, the control unit 180 stores at least one file in the new document box. That is, as described above, the files stored in the storage medium 200 or the image forming apparatus 100 may be automatically added to the document box. Alternatively, the files may be added to the document box by the user manipulating the user interface unit 160.

Referring to FIGS. 5 and 6, the file managing methods according to exemplary embodiments may include operations that are performed in time series in the image forming apparatus 100 and storage medium 200 of FIG. 1. Therefore, the description with reference to the image forming apparatus 100 and storage medium 200 of FIG. 1 may apply to the methods of managing the files of the image forming apparatus 100 of FIGS. 5 and 6.

Accordingly, the image forming apparatus 100 may recognize the document box of the storage medium 200 using the information file realizing the document box. That is, according to the methods of managing the files of the image forming apparatus 100 in accordance with the embodiments, a user interface that recognizes the document box stored in the storage medium 200 in the same form as the document box stored in the image forming apparatus 100 may be provided. Accordingly, the document box may be realized in the storage medium 200 by an operating system of the image forming apparatus 100 and the user interface, without adding a new element to the image forming apparatus 100 or the storage medium 200.

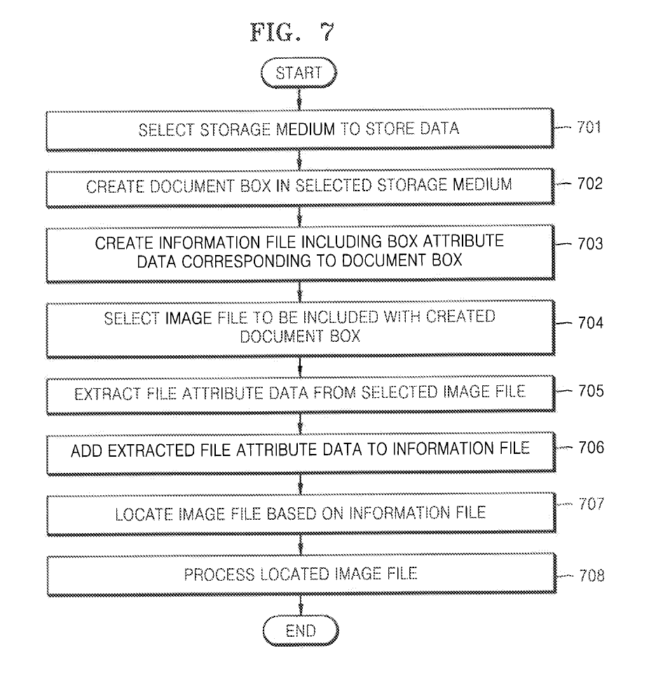

Referring now to FIG. 7, an exemplary method according to an alternative embodiment of the general inventive concept is illustrated. Specifically, a storage medium to store data is selected at operation 701. At operation 702, a document box is created in the selected storage medium. At operation 703, an information file is created, which may include box attribute information corresponding to the document box created in operation 702. An image file to be included with the created document box is selected at operation 704. At operation 705, file attribute information is extracted from the selected image file, and the extracted file attribute information is added to the information file at operation 706. Accordingly, an image file to be processed by the image forming apparatus 100 may be located in operation 707 based on the information file, and the method may end after the located image file is processed at operation 708.

Therefore, the user may conveniently perform a printing function, scanning function, copying function, fax sending function, e-mail sending function, file transferring function to the server, and the like according to the document box function using the files stored in the storage medium 200 in the image forming apparatus 100.

According to at least one exemplary embodiment of the general inventive concept, files of an image forming apparatus may be conveniently managed by a document box function realized in a storage medium by an information file. Using the document box realized in the storage medium, the user may conveniently perform the printing function, scanning function, copying function, fax sending function, e-mail sending function, file transferring function to the server, and the like corresponding to the files stored in the storage medium.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A method of managing files of an image forming apparatus including a display unit and connectable to at least one storage medium having a document box, the method comprising:
connecting the storage medium to the image forming apparatus;
determining if an information file corresponding to the at least one document box exists in the storage medium;
searching for at least one file stored in the document box corresponding to the existed information file in response to determining that the information file exists; and
displaying at least one of the searched file and the document box on the display unit,
wherein the image forming apparatus performs at least one of a printing function, a scanning function, a copying function, a fax sending function, an e-mail sending function, a file transferring function to a server, and a document box function.

2. The method of claim 1, further comprising creating a new document box and an information file corresponding to the new document box when it is determined that no information file exists.

3. The method of claim 1, wherein the searching for at least one file comprises:
searching for at least one file usable in the image forming apparatus among the files stored in the storage medium; and
adding file attribute information regarding the searched file to the information file.

4. The method of claim 3, wherein the file attribute information comprises at least one of a file name, information regarding security, a file format, and a storage path.

5. The method of claim 1, further comprising:
selecting a file among the displayed files; and
performing a function supported by the image forming apparatus using the selected file.

6. The method of claim 1, further comprising:
performing login of the image forming apparatus; and
verifying authentication information corresponding to the login in the image forming apparatus.

7. An image forming apparatus connectable to at least one storage medium having a document box, comprising:
a communication unit to communicate the storage medium with the image forming apparatus;
a determining unit to determine if an information file corresponding to the at least one document box exists in the connected storage medium;
a searching unit to search for at least one file stored in the document box corresponding to the existed information file in response to determining that the information file exists;
a displaying unit to display at least one of the searched file and the document box on the display unit; and
a control unit to control the image forming apparatus such that the image forming apparatus performs at least one of a printing function, a scanning function, a copying function, a fax sending function, an e-mail sending function, a file transferring function to a server, and a document box function.

8. The image forming apparatus of claim 7, further comprising:
a document box creating unit to create a new document box when it is determined that no information file exists; and
an information file creating unit to create an information file corresponding to the new document box.

9. The image forming apparatus of claim 7, wherein the searching unit searches for at least one file usable in the image forming apparatus among the files stored in the storage medium and further comprising a managing unit to add file attribute information regarding the searched file to the information file.

10. The image forming apparatus of claim 9, wherein the attribute information comprises at least one of a file name, information regarding security, a file format, and a storage path.

11. The image forming apparatus of claim 7, further comprising an input unit f to receive information on selection of a file among the displayed files, wherein the control unit controls such that a function supported by the image forming apparatus is performed using the file based on the received information.

12. The image forming apparatus of claim 7, further comprising an input unit to receive log in information and a verifying unit to verify the log in information in the image forming apparatus.

13. The image forming apparatus of claim 7, wherein the storage medium comprises at least one of a removable storage medium, a Universal Serial Bus (USB) memory, a memory card, an external hard disk drive (HDD), a computer system connectable to the image forming apparatus, and a server connectable to the image forming apparatus.

14. A method of managing files of an image forming apparatus having a display unit and a storing unit and connectable to at least one storage medium having a document box, the method comprising:
connecting the storage medium to the image forming apparatus;
displaying an image corresponding to a document box function on the display unit of the image forming apparatus;
selecting a location where a new document box will be created in one of the storing unit and the storage medium through the displayed image;
creating the new document box at the selected one of the storing unit and the storage medium; and
storing the file in the new document box.

15. The image forming apparatus of claim 14, further comprising creating an information file corresponding to the new document box.

16. An image forming apparatus connectable to at least one storage medium, comprising:
a user interface to select an image file and the at least one storage medium;
a document box creating module to create a document box in a selected storage medium to include with the document box an image file selected via the user interface;
an information creating module to create an information file including box attribute information corresponding to the document box; and
a managing module to extract file attribute information from the selected image file and add the extracted file attribute information to the information file.

17. The image forming apparatus of claim 16, further comprising a control module to locate the image file based on the information file and to control the image forming apparatus to process the image file.

18. The image forming apparatus of claim 16, wherein the box attribute data includes at least one of a document box name and a document box owner and information regarding security of the document box.

19. The image forming apparatus of claim 16, wherein the file attribute data includes at least one of a file name, information regarding security of the image file, a file format, and a file storage path.

20. A method of managing files processed by an image forming apparatus connectable to at least one storage medium, comprising:
selecting a storage medium from among the at least one storage medium;
creating a document box in the selected storage medium;
creating an information file including box attribute information corresponding to the document box;
selecting an image file to be included with the document box;
extracting file attribute information from the selected image file; and
adding the extracted file attribute data to the information file.
